(19) United States
(12) Patent Application Publication
(10) Pub. No.: US 2025/0303299 A1
(43) Pub. Date: Oct. 2, 2025

(54) Synthetic Theater Operations Research Model GRAPHICAL USER INTERFACE

(71) Applicant: United States of America, As Represented by the Secretary of the Navy, Arlington, VA (US)

(72) Inventors: Andrew T. Payne, Fredericksburg, VA (US); Jared Luffman, Dahlgren, VA (US)

(73) Assignee: United States of America, as represented by the Secretary of the Navy, Arlington, VA (US)

(21) Appl. No.: 18/621,285

(22) Filed: Mar. 29, 2024

(51) Int. Cl. A63F 13/63; A63F 13/5378; A63F 13/822

(52) U.S. Cl. CPC A63F 13/63; A63F 13/5378; A63F 13/822

(57) ABSTRACT

A map model editing method for a campaign level analysis tool executed by a graphical user interface to reduce error rates, reduce time, and verify accuracy. The editing method includes providing, for display within a graphical user interface, a world map, providing a campaign displayed on the world map, providing at least one option for editing the campaign, executing the at least one option, and providing, for display within the graphical user interface, the edited campaign.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to campaign analysis tools. In particular, The Synthetic Theater Operations Research Model (STORM).

The Synthetic Theater Operations Research Model (STORM) is the primary campaign analysis tool used by the Office of the Chief of Naval Operations, Assessment Division OPNAV N81 and other Department of Defense organizations to aid in providing analysis to top-level officials on force structures, operational concepts, and military capabilities. This thesis describes how STORM works, analyzes the variability associated with many replications, and evaluates the trade-off between the expected number of replications and the precision and probability of coverage of confidence intervals. The results of this research provide OPNAV 81 with the ability to capitalize on STORMs full potential on a time-line conducive to its high-paced environment. The distribution of outcomes is examined via standard statistical techniques for multiple metrics. All metrics appear to have sufficient variability, which is critical in modeling the combat environment. The trade-off for confidence intervals between the expected number of replications, precision, and the probability of coverage is very important. If a more precise solution and a higher probability of coverage are required, more replications are generally needed. This relationship is explored and a framework is provided to conduct this analysis on simulation output data.

### SUMMARY

In one embodiment, a map model editing method for a campaign level analysis tool executed by a graphical user interface to reduce error rates, reduce time, and verify accuracy is disclosed. The map model editing method includes displaying within a graphical user interface a world map, displaying a campaign displayed on the world map, at least one option for editing the campaign, executing the at least one option, and displaying, within the graphical user interface, the edited campaign. In a further embodiment, the map model editing method includes executing a simulation based on the at least one option, and storing the results of the simulation. In a further embodiment, the map model editing method includes analyzing the at least one option to determine if it is an illegal modification. In a further embodiment, the map model editing method of includes displaying, within the graphical user interface, the campaign of a blue force with a campaign of a red force, wherein the blue and red force are viewable and editable in the same world map. In a further embodiment, the map model editing includes providing geographical locations to entities and events that occurred in the simulation. In a further embodiment, the map model editing method includes providing, in the graphical user interface, information such as inventory, composition of units and engagement history. In a further embodiment, the information may further include targets Killed by Killer by Day and or Sorties by Airbase by Aircraft by Time. In a further embodiment, the at least one option may include an environment option. In a further embodiment, the at least one option may include an air combat option.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a comparison of the text based STORM interface and the graphical user interface STORM;

FIGS. 2A and 2B disclose a flow chart of an implementation of the present disclosure;

FIGS. 3A-E is the STORM graphical user interface showing a campaign on three-dimensional world map; and

FIG. 4 is the STORM conceptual model.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

The following thesis is hereby incorporated by reference in its entirety: Christian N. Seymour, ©2014, “CAPTURING THE FULL POTENTIAL OF THE SYNTHETIC THEATER OPERATIONS RESEARCH MODEL (STORM).” This incorporation by reference includes the working examples, figures, literature citations, materials and methods, and results and discussion.

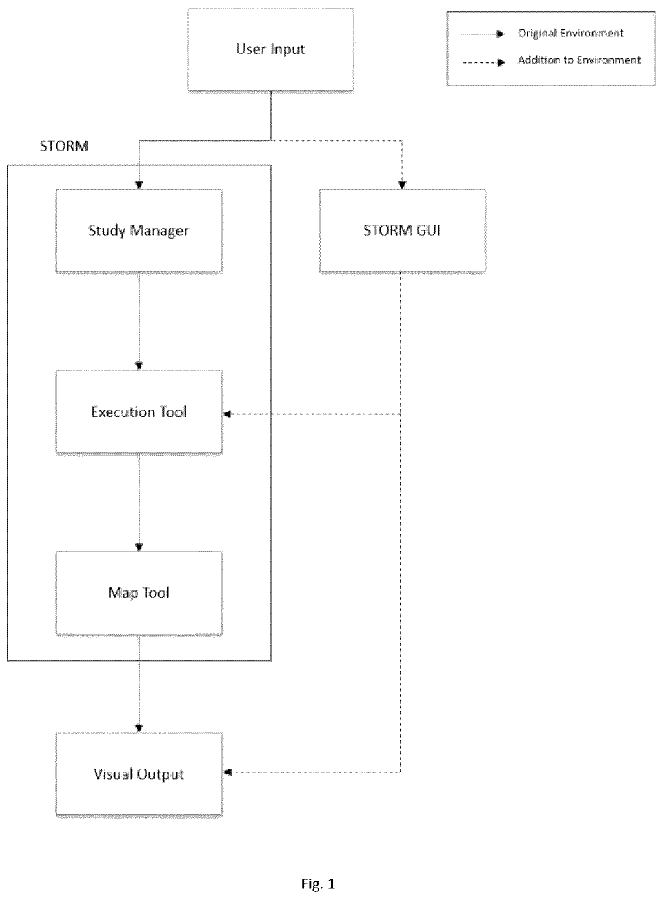

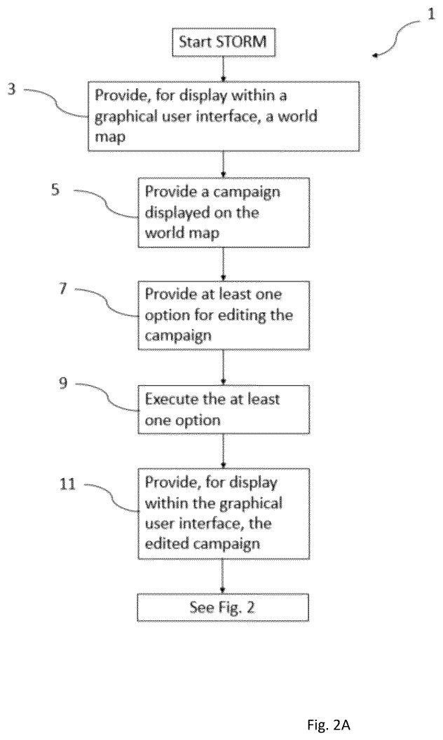

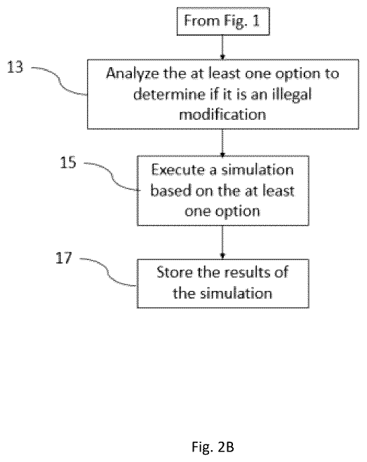

FIG. 1 is a comparison of the text based STORM interface and the STORM graphical user interface (GUI). The STORM GUI replaces the text based STORM Study Manager, as such the STORM GUI feeds directly into the Execution Tool. The STORM GUI also provides visual output, which removes the requirement to use the Map Tools. The introduction of the STORM GUI reduces the number of components in the system thereby simplifying the user's interaction with STORM. Further, the STORM GUI adds a built-in error check and direct modification of map features such as asset placement. Assets include ships, planes, satellites, and other equipment necessary to conduct a campaign. One example of the built-in-error check is that the text based system could result in a ship crossing land due to erroneous user inputs. The STORM GUI has STORM syntax and logic rules built into it so there is no chance of model execution being unsuccessful. Further, the direct modification of map features removes the need to iteratively change location data so the steps, “Execute the model”, “Open map tool”, and “Are locations correct?” are removed from the old process. Another advantage of the STORM GUI is that the GUI is a common interface. As such, it allows multiple networks to be edited at the same time, as whereas the text based interface does not, as seen in FIG. 8. Instead of the user going back and forth between interfaces and making incremental changes, they can make all changes in one window

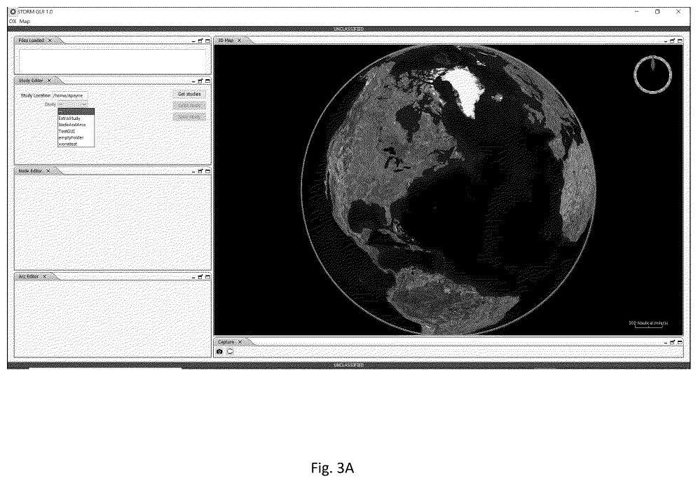

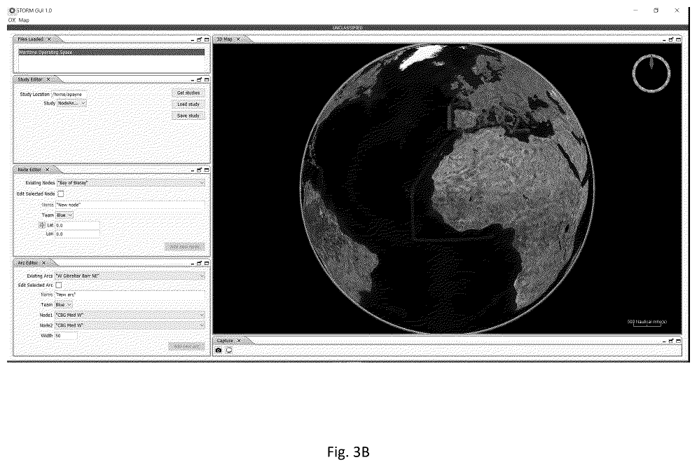

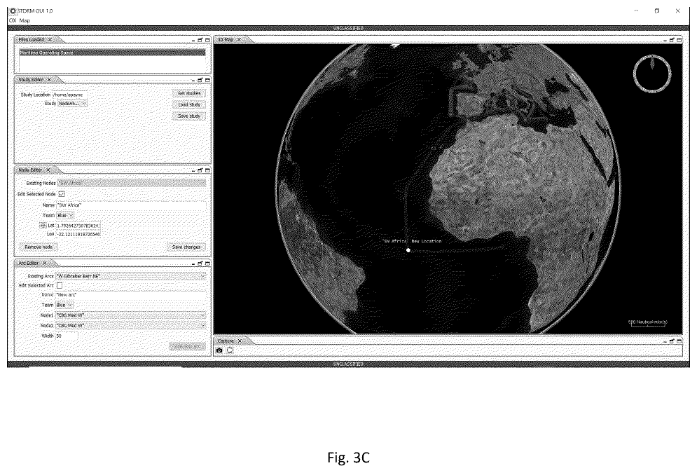

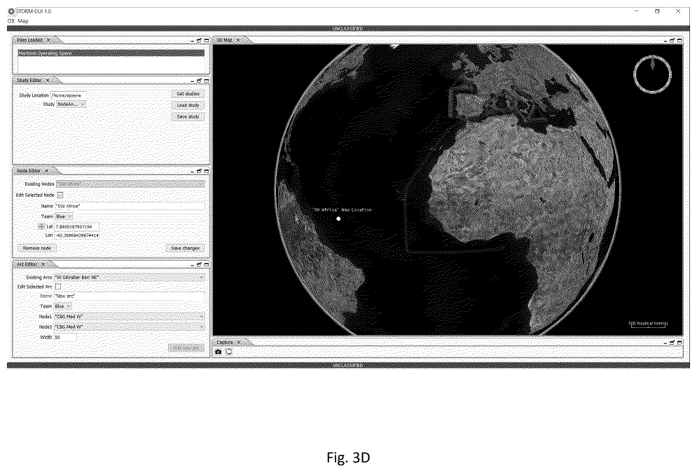

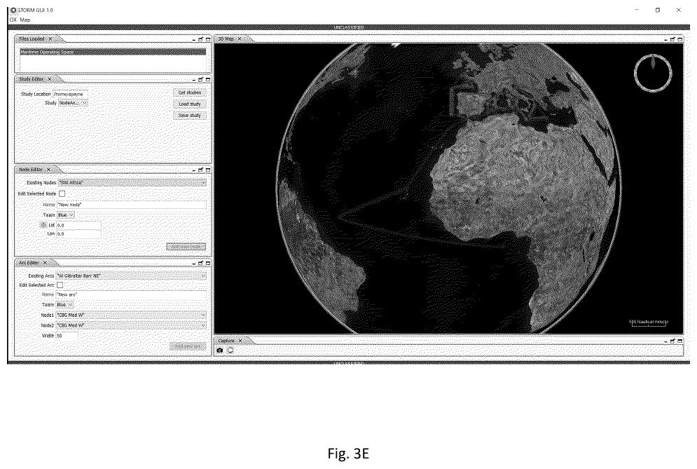

FIGS. 2A and 2B disclose a flow chart 1 of an implementation of the present disclosure. In FIG. 2A, in block 3, Storm provides a world map within the graphical user interface as shown in FIG. 3A. In block 5, the user selects a campaign to be displayed on the world map as shown in FIG. 3B. In block 7, at least one option for editing the campaign is provided. In FIG. 3C, a node is shown as the option to be edited. This node is moved from the location shown in FIG. 3C to the location shown in FIG. 3D. In block 9, STORM executes the edited campaign. The map gives a geographical location to the entities and events that have occurred in the simulation. Additional information such as inventory, composition of the unit and engagement history can be displayed by clicking on an icon in the mapping application. The information may further include targets Killed by Killer by Day and or Sorties by Airbase by Aircraft by Time. The editable options may include an environment option which addresses geospatial location, time, geophysical conditions and the geopolitical situation. A subset of the environment option may include battlespace addresses geospatial location; scenario addresses time; regions, terrain, weather and maritime environment address geophysical conditions; and sides addresses the geopolitical situation.

In block 11, the STORM GUI provides the edited display. In FIG. 2B, block 13, STORM analyzes the at least one option to determine if the modification is illegal. Essentially, a modification is illegal if it is physically impossible such as sailing a ship across land. In block 15, STORM executes a simulation based on the at least one option. In block 17, STORM stores the results of the simulation.

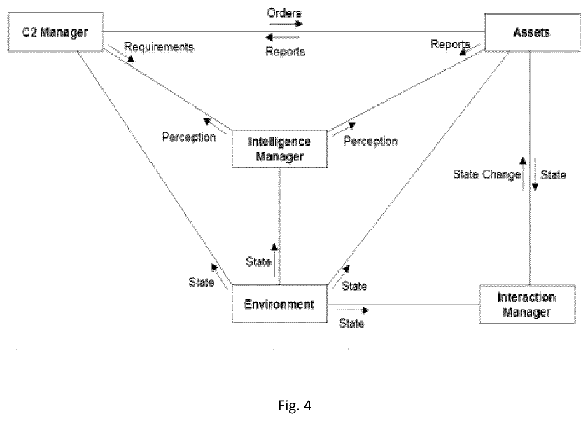

FIG. 4 is the STORM conceptual model. As shown in FIG. 4, STORM is a multi-sided, stochastic computer simulation of military operations covering the air, space, land and maritime domains. STORM is designed to provide campaign analysts with the ability to examine issues involving the utility and effectiveness of combat power in a theater-level, joint warfighting context. STORM models military operations from the real world with five classes: command and control (C2) manager, asset, intelligence manager, environment, and interaction manager. The flow concept of these classes can be seen in FIG. 4. In layman's terms, a conceptual model is a blueprint that illustrates how real-world elements—in STORM's case, elements from the military operations universe—are organized and related as elements of software code to function as a model. Particularly with regard to campaign-level models, this blueprint for portraying real world elements in software code can be confusing to uninitiated observers expecting to see a mirror image of reality. The modeling purpose of STORM is to coordinate asset behaviors. Command and Control (C2) Managers represent what in the real world are capabilities associated with strategic and operational planning bodies and decision-making processes. Typically they are implemented in a model through optimization techniques and algorithms. C2 Managers task Assets and receive status reports from Assets. They send collection requirements to the Intelligence Manager and receive perception from the Intelligence Manager. They receive state conditions from the Environment. Their efficiency is affected by the state of specific communications and C2 Assets. STORM has numerous implementations of this meta-class, differentiated by side (Blue, Red), domain (e.g., air, surface, sea, space) and functional area (e.g., air defense, logistics, mobility). As an example, an air tasking order (ATO) Generator functions as a C2 Manager for the Blue air domain by assessing the availability of aircraft, the supply and location of weapons, the comparative lethality of weapons against various target types and other conditions to match resources to tasks and assign specific missions and targets to particular squadrons.

Assets in STORM are entities that act or are acted upon. Therefore, they have the ability to complete activities like move, attack, conduct surveillance, or be killed. Examples of three different types of assets can be seen in Table 1. Surface Asset Air Asset Orbital Asset Armored Units Aircraft Satellites Ships Squadrons Space-based platforms Airbases Munitions Logistics Nodes Unmanned Aerial Vehicle (UAV) Table 1.

TABLE 1
Asset examples from STORM.

| Surface Asset | Air Asset | Orbital Asset |
|---|---|---|
| Armored Units | Aircraft | Satellites |
| Ships | Squadrons | Space-based platforms |
| Airbases | Munitions | |
| Logistics Nodes | Unmanned Aerial Vehicle | |
| | (UAV) | |

Asset examples from STORM. Assets are tasked by the C2 manager and receive perceptions from the intelligence manager, weather changes from the environment manager, and state changes from the interaction manager. They also communicate status reports and state changes to the intelligence manager and interaction manager, respectively. Each type of asset has explicit information embedded in it such as mobility, location, and intelligence, surveillance, and reconnaissance (ISR) characteristics.

The purpose of the environment class is to model real-world environmental conditions such as time of day, weather, and terrain. The environment in which an asset is operating affects its capabilities. For example, environmental factors, such as high sea state, darkness, and dense fog, may affect the ISR capabilities of numerous assets.

Interactions take place when two or more assets have the opportunity to affect one another. The three types of interaction managers are the motion managers, adjudication managers, and support managers. The motion manager is responsible for the movement of assets in response to their tasking and battle space dynamics, subject to resource and environmental constraints. The adjudication manager provides the result of engagements between two or more assets in combat, sensing, or communication missions. The support manager enables the movement and interaction of assets, subject to resource and environmental constraints, such as airbase operations.

The intelligence manager provides perceptions to the C2 manager and assets. Information is gathered by different ISR platforms and analyzed to provide information like targeting data. Intelligence is not always correct—and, therefore, can lead to bad targeting data.

The command and control (C2) manager tasks and receives reports from assets. In addition, requests for intelligence are sent to the intelligence manager, and perceptions are sent from the intelligence manager back to the C2 manager. The objective of the C2 manager is to coordinate asset behaviors to meet operational and strategic goals. The decision-making process is modeled using optimization techniques and other algorithms.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A map model editing method for a campaign level analysis tool executed by a graphical user interface to reduce error rates, reduce time, and verify accuracy, the map model editing method comprising:
providing, for display within a graphical user interface, a world map;
providing a campaign displayed on the world map;
providing at least one option for editing the campaign;
executing the at least one option; and
providing, for display within the graphical user interface, the edited campaign.

2. The map model editing method of claim 1 further comprising:
executing a simulation based on the at least one option; and
storing the results of the simulation.

3. The map model editing method of claim 1 further comprising:
analyzing the at least one option to determine if it is an illegal modification.

4. The map model editing method of claim 1 further comprising:
providing, for display within the graphical user interface, the campaign of a blue force with a campaign of a red force, wherein the blue and red force are viewable and editable in the same world map.

5. The map model editing method of claim 2 further comprising:
providing geographical locations to entities and events that occurred in the simulation.

6. The map model editing method of claim 2 further comprising:
providing, in the graphical user interface, information such as inventory, composition of units and engagement history.

7. The map model editing method of claim 6 wherein the information may further include targets Killed by Killer by Day and or Sorties by Airbase by Aircraft by Time.

8. The map model editing method of claim 1 further wherein the at least one option may include an environment option.

9. The map model editing method of claim 1 further wherein the at least one option may include an air combat option.
